(19) United States
(12) Patent Application Publication
(10) Pub. No.: US 2026/0193056 A1
(43) Pub. Date: Jul. 9, 2026

(54) LIFT SYSTEM

(71) Applicant: INVENTIO AG, Hergiswil (CH)

(72) Inventors: Philipp Zimmerli, Harkingen (CH); Samuel Ulmer, Luzern (CH)

(21) Appl. No.: 19/132,785

(22) PCT Filed: Jan. 24, 2024
(86) PCT No.: PCT/EP2024/051590

§ 371 Date: May 23, 2025

(30) Foreign Application Priority Data
Jan. 30, 2023 (EP) 23153876.0

(51) Int. Cl. B66B 7/02; B66B 5/00; B66B 9/00

(52) U.S. Cl. CPC B66B 7/021; B66B 5/0081; B66B 7/024; B66B 9/00; B66B 11/0005

(57) ABSTRACT

Provided is an elevator system comprising an elevator shaft having a first movement path for a first elevator car and a second movement path for a second elevator car. The first and second movement paths are arranged adjacently in a width direction. First intermediate supports are arranged between the first and second movement paths, and are spaced apart in the vertical direction, and extend perpendicular to the width direction. Second intermediate supports spaced apart in the vertical direction are arranged between the first and second movement paths. A third movement path for a first counterweight and a fourth movement path for a second counterweight are arranged between the first and second intermediate supports. At least two guide rails for the first and second elevator cars and the first and second counterweights are connected to a connecting element arranged in the vertical direction between two first intermediate supports.

The invention relates to an elevator system according to the preamble of claim 1.

Elevator systems are used to transport persons and/or goods between floors of buildings. For this purpose, at least one elevator car accommodating passengers and/or goods is moved in an elevator shaft, in particular vertically between the floors. Depending on the transport capacity required in the building, an elevator system can have only one elevator car or multiple elevator cars, which can be moved independently of each other in adjacent movement paths of the elevator shaft. An elevator system with multiple movement paths for elevator cars can be called a group elevator. The aforementioned movement paths for the elevator cars of a group elevator are usually not separated from each other by walls, but rather by intermediate supports to which components of the elevator system, in particular guide rails for guiding the elevator cars, are attached. Guide rails are usually composed of individual guide rail pieces put together and assembled. In the following, a guide rail is understood to mean a complete guide rail and/or a guide rail piece, depending on the context.

EP 0397064 B1 describes an elevator system having an elevator shaft with a first movement path for a first elevator car of the elevator system and a second movement path for a second elevator car of the elevator system. The first movement path and the second movement path are arranged next to each other in a width direction of the elevator shaft. A plurality of first intermediate supports are arranged between the first movement path and the second movement path, and are spaced apart from one another in the vertical direction, and extend in a depth direction of the elevator shaft perpendicular to the width direction. The first elevator car is connected to a first counterweight of the elevator system via a first suspension means and the second elevator car is connected to a second counterweight of the elevator system via a second suspension means. The elevator shaft has a third movement path for the first counterweight and a fourth movement path for the second counterweight. The third movement path for the first counterweight is arranged between the first movement path for the first elevator car and a shaft wall of the elevator shaft adjacent in the depth direction to the first movement path for the first elevator car. The fourth movement path for the second counterweight is arranged between the second movement path for the second elevator car and the first intermediate supports.

JPS60178177A and CN107804767A also describe elevator systems, each having an elevator shaft, a first movement path for a first elevator car, a second movement path for a second elevator car, a third movement path for a first counterweight and a fourth movement path for a second counterweight. The JPS6481782A describes a generic elevator system.

In contrast, it is in particular the object of the invention to propose an alternative elevator system with an elevator shaft with two movement paths arranged side by side for elevator cars of the elevator system. According to the invention, this object is achieved by an elevator system having the features of claim 1.

The elevator system according to the invention has an elevator shaft with a first movement path for a first elevator car of the elevator system and a second movement path for a second elevator car of the elevator system. The first movement path and the second movement path are arranged next to each other in a width direction of the elevator shaft. A plurality of first intermediate supports are arranged between the first movement path and the second movement path, and are spaced apart from one another in the vertical direction, and extend in a depth direction of the elevator shaft perpendicular to the width direction. A plurality of second intermediate supports are arranged between the first movement path and the second movement path, and are spaced apart from one another in a depth direction of the elevator shaft. The second intermediate supports are arranged at a distance from the first intermediate supports in the width direction. A third movement path for a first counterweight of the elevator system connected to the first elevator car via a first suspension means, and a fourth movement path for a second counterweight of the elevator system connected to the second elevator car via a second suspension means, are arranged between the first intermediate supports and the second intermediate supports.

According to the invention, the elevator system has guide rails for the first elevator car, the second elevator car, the first counterweight and the second counterweight, and a connecting element which is arranged in the vertical direction between two first intermediate supports arranged directly one above the other, and which is connected to two—and in particular, to all four—of the aforementioned guide rails. The connecting element is arranged in particular in the vertical direction centrally between the two aforementioned first intermediate supports.

The connecting element increases the rigidity of the guide rails connected to it. This makes it possible to use guide rails that are particularly small in terms of their cross-section, which would not have the necessary rigidity without a connection to the connecting element. The use of the small guide rails mentioned above results in guide rails that are particularly light and made of little material. This enables a particularly cost-effective and resource-saving implementation of the guide rails and thus the elevator system. In addition, lightweight guide rails can be transported and installed in the elevator shaft more easily and therefore more cost-effectively.

The connecting element has in particular an elongated shape in the width direction of the elevator shaft and is designed, for example, as a rod or a tube with optional attachments. For example, it can be bolted to the guide rails. In particular, it is also possible for the guide rails to be attached to the connecting element by means of so-called rail clamps, which are also used with rail brackets to attach guide rails to shaft walls or intermediate supports. The connecting element can have corresponding contact surfaces with threaded pins or threaded holes.

The arrangement of the movement paths for the counterweights between the first and second intermediate supports takes up particularly little space in the cross-section of the elevator shaft. This means that an elevator system with such an elevator shaft can have elevator cars with particularly large cross-sections and thus floor areas. Or, with given cross-sections and thus floor areas of the elevator cars, the elevator shaft can have a particularly small cross-section.

Guide rails for guiding the first and second counterweights, as well as the first and second elevator cars, during movement in the elevator shaft can be attached at least indirectly to the first and second intermediate supports. The first and second intermediate supports thus fulfill multiple tasks, so that further components can be omitted. This means that the elevator shaft can be constructed using little material, especially little metal. This allows for a cost-effective, resource-saving production of the elevator shaft.

In the elevator shaft in accordance with EP 0397064B1, in order to be able to attach guide rails for the second counterweight and the second elevator car to the first intermediate supports, plates, rods and bolts are mounted on the first intermediate supports using nuts. This mounting takes time and incurs costs. In the elevator shaft according to the invention, guide rails can be fixed directly to the intermediate supports. Installing guide rails in the elevator shaft is therefore simple, quick and cost-effective.

The elevator shaft is delimited in particular by solid shaft walls, which can be made of concrete or wood, for example. However, it is also possible that the elevator shaft is delimited by a supporting structure, particularly made of metal.

The elevator shaft and thus also the movement paths for the independently movable elevator cars and the counterweights of the elevator shaft connected to the elevator cars run primarily vertically, although minor deviations from the vertical are possible. The individual movement paths are each designed as mainly cuboid-shaped, non-overlapping spaces in which an elevator car or a counterweight can be moved vertically.

A vertical extension of the elevator shaft can be called a height of the elevator shaft. A vertical position within the elevator shaft can be referred to as a height in the elevator shaft. In particular, the elevator shaft has a primarily cuboid basic shape. It therefore has a height extending in the vertical direction, a width extending in the width direction and a depth extending in the depth direction.

In particular, the elevator shaft has shaft openings at different heights, wherein a shaft opening is usually assigned to a floor of the building containing the elevator shaft. When stopping at a floor, a car door of an elevator car and a shaft door arranged in a shaft opening are aligned with each other in such a way that it is possible to enter and exit the elevator car via the car door and the shaft door.

Shaft openings assigned to a floor are arranged next to each other, particularly in the width direction of the elevator shaft. It is also possible for an elevator car to have two opposite car doors, so that at least on one floor the elevator shaft also has opposite shaft openings.

The elevator shaft may also have more than two movement paths for elevator cars and more than two movement paths for counterweights.

The first and second intermediate supports run in the depth direction, wherein the depth direction does not have to be exactly perpendicular to the width direction; a small deviation is possible. The first and second intermediate supports also run particularly horizontally. In the elevator shaft, a first intermediate support and a corresponding second intermediate support are arranged in pairs at different heights. For example, a first intermediate support and a corresponding second intermediate support have a distance of between 70 and 100 cm. For example, two first or second intermediate supports arranged vertically one above the other have a distance of between 200 and 400 cm.

The first and second intermediate supports have an elongated shape and are supported in particular on opposite shaft walls. In the case of shaft walls made of concrete, for example, they can be cast in when the shaft walls are poured. It is also possible that the shaft walls are cast first and the intermediate supports are then attached to the shaft walls, for example by bolting. The shaft walls can also have ledges or niches on which the intermediate supports can be supported from above. It is also possible that of a first and a corresponding second intermediate support, only one of the two intermediate supports is supported on opposite shaft walls and the other intermediate support is attached to the intermediate support supported on the shaft walls.

The first and second intermediate supports are designed in particular as metal beams, for example as hollow profiles with a rectangular cross-section, T-beams or double-T-beams, with optional attachments. The intermediate supports in particular have fastening options for attaching guide rails of the elevator system to the intermediate supports. The fastening options can be designed, for example, as elongated holes or threaded pins.

The arrangement of the third movement path for the first counterweight and the fourth movement path between the first and second intermediate supports results in the first intermediate supports and the second intermediate supports being designed and arranged such that the first and second counterweights can be displaced vertically between them.

In an embodiment of the invention, a first intermediate support and a corresponding second intermediate support of the elevator shaft run parallel to each other and at the same height in the elevator shaft. In particular, guide rails of the elevator system are attached to the intermediate supports. Due to the aforementioned arrangement of the intermediate supports, an installer located on an installation platform can attach guide rails to a first and a second intermediate support during installation of the elevator system without having to change the position of the installation platform in the vertical direction. This enables a particularly simple, quick, and therefore cost-effective installation of the elevator system.

In an embodiment of the invention, the first intermediate support and the corresponding second intermediate support of the elevator shaft are connected with a cross-beam. Components of the elevator system, in particular guide rails, can also be attached to the cross-beam. The cross-beam, like the intermediate supports, can have corresponding fastening options. The cross-beam enables particularly simple, quick and therefore cost-effective installation of the elevator system. In addition, the cross-beam can contribute to a high stability of a combination of a first intermediate support and a corresponding second intermediate support.

The cross-beam runs in particular in the width direction of the elevator shaft and horizontally when the intermediate supports are arranged parallel and at the same height. More than one cross-beam, for example two or three cross-beams, can be arranged between a first intermediate support and a corresponding second intermediate support. For example, a cross-beam can be arranged between the third movement path for the first counterweight and the fourth movement path for the second counterweight. It is also possible that alternatively or additionally cross-beams are arranged between the third and/or fourth movement path and a wall delimiting the elevator shaft. This allows guide rails for the first and/or second counterweight to be attached to a cross-beam and not to the aforementioned wall of the elevator shaft. Fastening to a cross-beam is usually easier, faster and therefore more cost-effective than to a wall of the elevator shaft, especially if it is made of concrete.

In an embodiment of the invention, in the elevator system a first intermediate support and a corresponding second intermediate support of the elevator shaft run at the same height in the elevator shaft. The first intermediate support and the corresponding second intermediate support are connected to a cross-beam, and a guide rail for the first counterweight and/or the second counterweight is attached to the cross-beam. For this embodiment of the elevator system, the above statements regarding one or more cross-beams of an elevator shaft apply accordingly.

In an embodiment of the invention, the third movement path for the first counterweight and the fourth movement path for the second counterweight are arranged next to each other in the depth direction of the elevator shaft.

This arrangement of the third and fourth counterweight results in the third movement path for the first counterweight connected to the first elevator car being arranged next to the second movement path for the second elevator car, and the fourth movement path for the second counterweight connected to the second elevator car being arranged next to the first movement path for the first elevator car. This means that the second counterweight can move past a stationary first elevator car and the first counterweight can move past a stationary second elevator car. In particular, a first protective element extending upwards from a roof of the first elevator car is arranged on the first elevator car. The protective element can be designed, for example, as a protective wall in the form of a metal sheet or a Plexiglas wall, as a lattice screen, or as a net stretched in a frame, for example a textile net or a wire net. The first protective element extends in the depth direction along the fourth movement path for the second counterweight. This protects an installer or service technician on the roof of the first elevator car from a collision with the second counterweight. The first protective element prevents in particular the installer or service technician from leaning over the edge of the first elevator car and thus out of the first movement path of the first elevator car into the fourth movement path of the second counterweight.

In particular, the first protective element extends at least over the entire fourth movement path. For example, it has a height of 150-220 cm from the roof of the first elevator car. For example, it can be designed to be foldable so that it is only deployed when an installer or service technician is on the first elevator car. The position of the first protective element can be monitored, for example, by means of suitable sensors.

In particular, the elevator system also has on the second elevator car a second protective element extending upwards from a roof of the second elevator car and extending in the depth direction along the third movement path for the first counterweight. The statements regarding the first protective element apply accordingly to the second protective element.

In an embodiment of the invention, the aforementioned connecting element is connected to a first intermediate support and/or to a second intermediate support by means of a strut.

This enables a high level of stability and rigidity of the system consisting of a connecting element and two or four guide rails. This means that the described effects and advantages of the connecting element are particularly pronounced.

The strut is designed, for example, as a simple, elongated metal rod, which has, for example, receptacles at its ends for screwing to the connecting element or an intermediate support. The strut can also be designed as a cable, in particular a steel cable with appropriate holders. The cable can be tensioned accordingly to achieve the desired stability or stiffness.

The connecting element is connected in particular by means of a strut to a first intermediate support arranged above the connecting element, a second intermediate support arranged above the connecting element, a first intermediate support arranged below the connecting element and a second intermediate support arranged below the connecting element. This enables a particularly high level of stability and rigidity of the system consisting of a connecting element and two or four guide rails.

Further advantages, features, and details of the invention can be found in the following description of embodiments and with reference to the drawings, in which like or functionally like elements are provided with identical reference signs. The drawings are merely schematic and are not to scale.

In the figures:

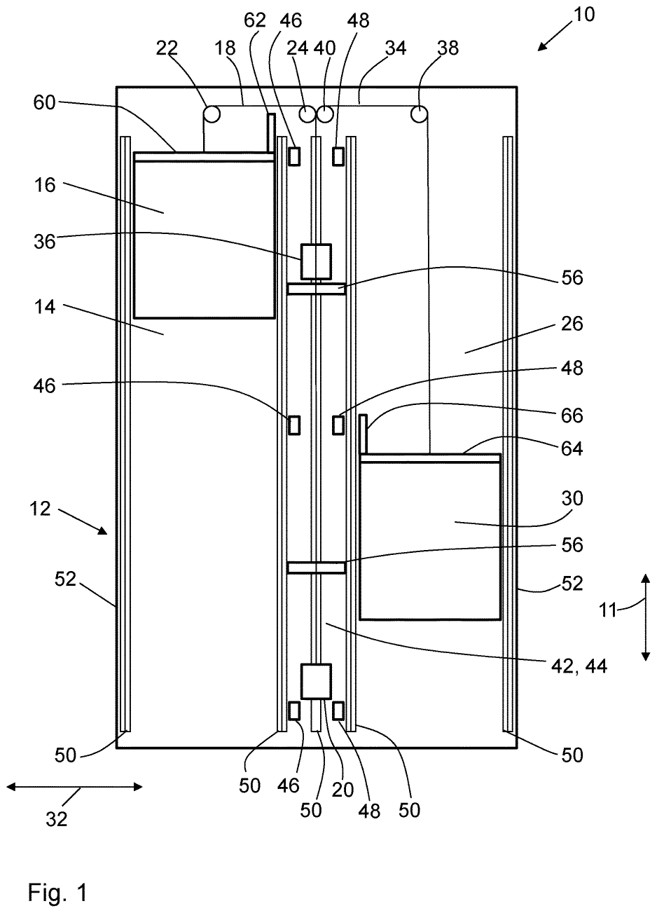

FIG. 1 is a side view of an elevator system with two elevator cars that can be moved independently of each other in an elevator shaft,

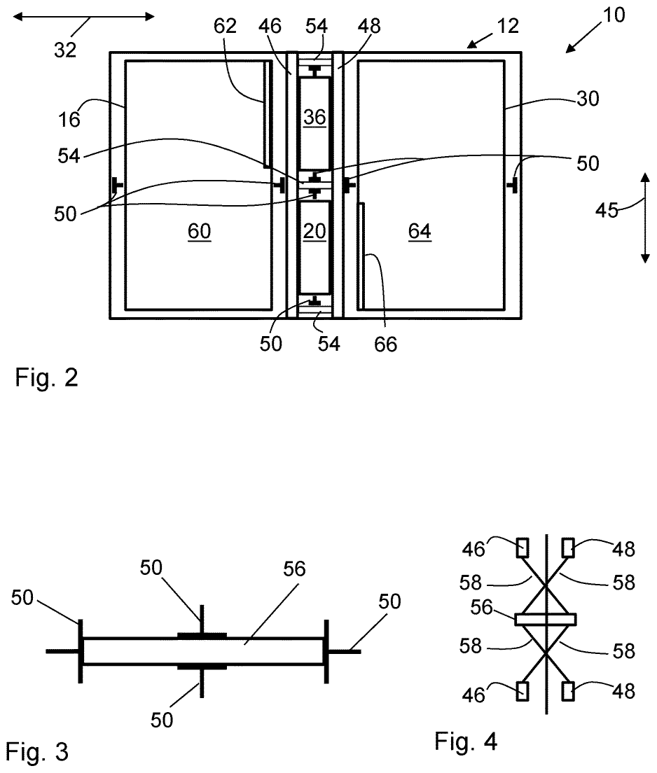

FIG. 2 is an elevator system of FIG. 1 from above,

FIG. 3 is a connecting element connecting guide rails of an elevator system, in a view from above, and

FIG. 4 is the connecting element of FIG. 3 with struts to intermediate supports of an elevator shaft, in a side view.

According to FIGS. 1 and 2, an elevator system 10 has an elevator shaft 12 extending in the vertical direction, and thus in a vertical direction 11, with a first movement path 14 for a first elevator car 16. The first elevator car 16 is connected to a first counterweight 20 via a first suspension means 18 in the form of a cable or a belt. The first suspension means 18 runs over a first drive pulley 22 arranged above the first elevator car 16 and a first deflection pulley 24 arranged above the first counterweight 20. The first drive pulley 22 can be driven by a first drive machine (not shown), such that the first suspension means 18 and thus the first elevator car 16 and the first counterweight 20 can be displaced vertically in the elevator shaft 12.

The elevator shaft 12 has a second movement path 26 for a second elevator car 30, which is arranged in a width direction 32 of the elevator shaft 12 next to the first movement path 14 for the first elevator car 16. The second elevator car 30 is connected to a second counterweight 36 via a second suspension means 34 in the form of a cable or a belt. The second suspension means 34 runs over a second drive pulley 38 arranged above the second elevator car 30 and a second deflection pulley 40 arranged above the second counterweight 36. The second drive pulley 38 can be driven by a second drive machine (not shown), whereby the second suspension means 34 and thus the second elevator car 30 and the second counterweight 36 can be displaced vertically in the elevator shaft 12. The two drive machines can be controlled independently of each other by an elevator controller (not shown), so that the first elevator car 16 and the second elevator car 30 can be moved independently of each other in the elevator shaft 12.

Between the first movement path 14 for the first elevator car 16 and the second movement path 26 for the second elevator car 30, a third movement path 42 for the first counterweight 20 and a fourth movement path 44 for the second counterweight 36 are arranged, wherein in FIG. 1 the third movement path 42 is arranged in front of the fourth movement path 44. The third movement path 42 and the fourth movement path 44 are thus arranged next to one another in a depth direction 45 running at right angles to the vertical direction 11 and at right angles to the width direction 32. A total of three first intermediate supports 46 run between the third movement path 42 or fourth movement path 44 and the first movement path 14. They run horizontally and in a depth direction 45 that is perpendicular to the vertical direction 11 and perpendicular to the width direction 32 and are spaced from one another in the vertical direction 11. In addition, a total of three second intermediate supports 48 run between the third movement path 42 or fourth movement path 44 and the second movement path 26. They are spaced apart from each other horizontally and in the depth direction 45 in the vertical direction 11, with two corresponding first and second intermediate supports 46, 48 running parallel and at the same height in the elevator shaft 12.

The elevator cars 16, 30 and the counterweights 20, 36 are each guided by a pair of guide rails 50, wherein the guide rails 50 of the two elevator cars 16, 20 are spaced apart from one another in the width direction 32 and the guide rails 50 of the two counterweights 20, 36 are spaced apart from one another in the depth direction 45. With respect to the elevator shaft 12, the external guide rails 50 of the two elevator cars 16, 30 are fastened to shaft walls 52 of the elevator shaft 12 by means of rail brackets and rail clamps (not shown). The second, inner guide rail 50 of the first elevator car 16 is fastened to the first intermediate supports 46 by means of rail brackets and rail clamps (not shown). The second, inner guide rail 50 of the second elevator car 30 is fastened to the second intermediate supports 48 by means of rail brackets and rail clamps (not shown).

The guide rails 50 of the two counterweights 20, 36 are fastened to cross-beams 54 connecting a first intermediate support 46 and a corresponding second intermediate support 48 by means of rail brackets and rail clamps (not shown). The elevator system 10 has a total of three cross-beams 54 per pair of a first intermediate support 46 and a second intermediate support 48, with a middle cross-beam 54 being arranged between the third movement path 14 and the fourth movement path 26 and an outer cross-beam 54 being arranged on the side of the two movement paths 14, 26 opposite the middle cross-beam 54.

It is also possible for the elevator system to have only one central cross-beam per pair of corresponding first and second intermediate brackets and for the external guide rails of the two counterweights to be attached to opposite walls of the elevator shaft.

In the vertical direction 11, a connecting element 56 is arranged between each pair of two first intermediate supports 46 arranged one above the other and corresponding second intermediate supports 48. The connecting elements 56 are arranged approximately centrally between two first intermediate supports 46 arranged one above the other. The connecting elements 56 have a cuboid basic shape and are connected to the inner guide rails 50 of the first and second elevator cars 16, 30 and the first and second counterweights 20, 36—for example by means of rail clamps. This is shown in FIG. 3 in an enlarged view from above.

According to FIG. 4, the connecting elements 56 can be connected by means of a strut 58 to a first intermediate support 46 arranged above the connecting element 56, a second intermediate support 48 arranged above the connecting element 56, a first intermediate support 46 arranged below the connecting element 56 and a second intermediate support 48 arranged below the connecting element 56. However, the connections mentioned above using struts are not absolutely necessary.

According to FIGS. 1 and 2, a first protective element 62 in the form of a protective wall is arranged on the first elevator car 16, extending from a roof 60 of the first elevator car 16 upwards, i.e. in the vertical direction 11. The first protective element 62 extends in the depth direction 45 along the fourth movement path 44 for the second counterweight 36. A corresponding second protective element 66 is arranged on a roof 64 of the second elevator car 30 and extends along the third movement path 42 for the second counterweight 30.

Finally, it should be noted that terms such as “having”, “comprising”, etc. do not preclude other elements or steps, and terms such as “a” or “an” do not preclude a plurality.

Furthermore, it should be noted that features or steps which have been described with reference to one of the above exemplary embodiments may also be used in combination with other features or steps of other exemplary embodiments described above. Reference signs in the claims should not be considered to be limiting.

1. Elevator system, comprising
an elevator shaft
a first elevator car,
a second elevator car,
a first counterweight connected to the first elevator car via a first suspension means, and
a second counterweight connected to the second elevator car via a second suspension means,
wherein the elevator shaft comprises:
a first movement path for the first elevator car, and
a second movement path for the second elevator car,
wherein
the first movement path and the second movement path are arranged next to each other in a width direction of the elevator shaft.
a plurality of first intermediate supports are arranged between the first movement path and the second movement path, and are spaced apart from one another in the vertical direction, and extend in a depth direction of the elevator shaft perpendicular to the width direction,
a plurality of second intermediate supports are arranged between the first movement path and the second movement path, and are spaced apart from one another in the vertical direction, and extend in a depth direction of the elevator shaft,
the second intermediate supports are arranged at a distance from the first intermediate supports in the width direction,
a third movement path for a first counterweight of the elevator system connected to the first elevator car via a first suspension means and a fourth movement path for a second counterweight of the elevator system connected to the second elevator car via a second suspension means are arranged between the first intermediate supports and the second intermediate supports,
guide rails are provided for the first elevator car, the second elevator car, the first counterweight and the second counterweight, and
a connecting element is arranged in the vertical direction between two first intermediate supports and connected to two of the aforementioned guide rails.

2. Elevator system according to claim 1, wherein a first intermediate support and a corresponding second intermediate support of the elevator shaft run parallel to each other and at the same height in the elevator shaft.

3. Elevator system according to claim 2, wherein the first intermediate support and the corresponding second intermediate support of the elevator shaft are connected by a cross-beam.

4. Elevator system according to claim 3, wherein a guide rail for the first counterweight and/or the second counterweight is attached to the cross-beam.

5. Elevator system according to claim 1, wherein the third movement path for the first counterweight and the fourth movement path for the second counterweight are arranged next to one another in the depth direction of the elevator shaft.

6. Elevator system according to claim 5, wherein a first protective element extending upwards from a roof of the first elevator car is arranged on the first elevator car, which extends in the depth direction along the fourth movement path for the second counterweight.

7. Elevator system according to claim 6, wherein a second protective element which extends upwards from a roof of the second elevator car and which extends in the depth direction along the third movement path for the first counterweight is arranged on the second elevator car.

8. Elevator system according to claim 1, wherein the connecting element is connected to four guide rails.

9. Elevator system according to claim 1, wherein the connecting element is connected to at least one of a first intermediate support and a second intermediate support by means of a strut.

10. Elevator system according to claim 9, wherein the connecting element is connected, in each case by means of a strut, to
a first intermediate support arranged above the connecting element,
a second intermediate support arranged above the connecting element,
a first intermediate support arranged below the connecting element, and
a second intermediate support arranged below the connecting element.
